(19) United States
(12) Patent Application Publication
(10) Pub. No.: US 2016/0086380 A1
(43) Pub. Date: Mar. 24, 2016

(54) HYPERSPECTRAL IMAGER

(71) Applicant: Invuity, Inc, San Francisco, CA (US)

(72) Inventors: Alex Vayser, Mission Viejo, CA (US); Gaston Tudury, San Francisco, CA (US)

(21) Appl. No.: 14/859,747

(22) Filed: Sep. 21, 2015

Related U.S. Application Data
(60) Provisional application No. 62/053,694, filed on Sep. 22, 2014.
(60) Provisional application No. 62/102,998, filed on Jan. 13, 2015.

(51) Int. Cl. G06T 19/00; G01J 3/28; H04N 5/232; G02B 27/01

(52) U.S. Cl. CPC G06T 19/006; G02B 27/0172; G01J 3/2823; H04N 5/23229; H04N 5/23293; G02B 2027/0138; G01J 2003/2826

(57) ABSTRACT

A system for augmenting a surgeon's view of a surgical field includes a hyperspectral imager and a display. The hyperspectral imager is configured to provide a hyperspectral image of tissue and anatomical structures in a surgical field. The display displays the image provided by the hyperspectral imager, and the image is registered with an actual view of the surgical field as seen by the surgeon thereby augmenting the surgeon's view of the surgical field.

### CROSS-REFERENCE

The present application is a non-provisional of, and claims the benefit of U.S. Provisional Patent Application Nos. 62/053,694 (Attorney Docket No. 40556-738.101) filed Sep. 22, 2014 and 62/102,998 (Attorney Docket No. 40556-738.102) filed Jan. 13, 2015; the entire contents of which are incorporated herein by reference.

### BACKGROUND OF THE INVENTION

1. Field of the Invention

The present application generally relates to medical devices, systems and methods, and more particularly relates to imaging devices that facilitate a physician or surgeon conduct a medical procedure.

Often times, it can be challenging for a surgeon to visualize various tissues or anatomical structures in a surgical field. For example, some tissue may be obstructed by other tissue, or blood may obstruct the field of view. This is undesirable since the obstructed tissue may be inadvertently damaged during a surgical procedure since it cannot be seen. Or, in other procedures where damaged or diseased tissue is to be removed, not all of the tissue may be completely removed because the tissue margins are not clearly visible. Therefore, it would be desirable to provide improved imaging systems that facilitate identification of tissue to a surgeon. Such systems should be easy to use and move around the surgical field. At least some of these objectives will be satisfied by the embodiments disclosed herein.

2. Description of the Background Art

N/A.

### SUMMARY OF THE INVENTION

The present invention generally relates to medical systems, devices and methods, and more particularly relates to devices and methods for augmenting a surgeon's view of tissue or a surgical field.

In preferred embodiments, an augmented view includes a hyperspectral image of a surgical field that is registered over the actual view of the surgical field as seen by the surgeon. Alternatively, a virtual view of the tissue or surgical field may be presented in which the entire scene is displayed on a display with specific tissue highlighted. Therefore, the difference between augmented and a virtual view is that in the augmented view, only the target tissue is highlighted and overlaid onto the surgeon's actual field of view. The surgeon does not have to look at a separate display during the procedure since (s)he will continue to look at the actual surgical field. While in a virtual view the entire scene is shown on a display that the surgeon observes during the procedure.

In a first aspect of the present invention, a system for augmenting a surgeon's view of a surgical field comprises a hyperspectral imager and a display. The hyperspectral imager is configured to provide a hyperspectral image of a surgical field. The display displays the image provided by the hyperspectral imager, and the image is registered with and superimposed or overlaid with an actual view of the surgical field as seen by the surgeon preferably through the display such as a headsup display. This forms and provides an augmented view of the surgical field.

The hyperspectral imager may be coupled to the display and the display may be a see through display. The display may be a heads up display. The hyperspectral imager may be a head mounted device. Registration of the image may align it with the actual view.

In another aspect of the present invention, a method for augmenting a surgeon's view of a surgical field comprises hyperspectrally imaging the surgical field with a hyperspectral imager, and displaying the hyperspectral image on a display. The hyperspectral image is registered with and overlaid and displayed on top of an actual view of the surgical field as seen by the surgeon thereby forming an augmented view, and this enhances identification of tissue or anatomical structures in the augmented view. The displaying may be performed with a heads up display through which the surgeon still can directly observe the surgical field. The hyperspectral image may be a head mounted device and the method may further comprise viewing the surgical field through the display.

In alternative embodiments, a virtual setup is used where the entire scene is displayed as video on a display unit (e.g. a monitor, a laptop screen, a tablet etc.) Therefore, there are no see through optics. The user sees the entire image on his display with the hyperspectral image registered over the anatomy.

The display may be a heads up display. The display may have a single or multiple cameras. One camera may be a hyperspectral camera and another camera may be a color camera, or a single camera may be used to combine both images by alternating frames, for example.

In another aspect of the present invention, a system for augmenting a surgeon's view of a surgical field comprises a hyperspectral imager configured to provide a hyperspectral image of a surgical field, and a projector for projecting the hyperspectral image onto the surgical field. The hyperspectral image is preferably projected directly onto the surgical field. In this exemplary option, a small pico projector may be mounted on a head mounted system that the user wears, and the projector projects the image that's captured by the camera directly in front of the user onto the surgical field. The hyperspectral image may be a head mounted device.

In still another aspect of the present invention, a method for augmenting a surgeon's view of a surgical field comprises hyperspectrally imaging the surgical field with a hyperspectral imager, projecting the hyperspectral image from a projector directly onto the surgical field, and enhancing identification of tissue or anatomical structures in the surgical field. The hyperspectral imager may be a head mounted device.

In another exemplary embodiment, a system for augmenting a surgeon's view of a surgical field and providing a virtual view of the surgical field comprises a hyperspectral imager, a camera, and a display. The hyperspectral imager is configured to provide a hyperspectral image of a surgical field. The camera is used to image the surgical field. The display displays both the image provided by the hyperspectral imager and the camera image. The hyperspectral image is registered with an integrated with the image provided by the camera to produce the augmented virtual view of the surgical field. The display may be an opaque display. The hyperspectral imager may be a head mounted device. Registration of the hyperspectral image preferably aligns it with the camera image.

In yet another aspect, a method for providing an augmented virtual view of a surgical field comprises hyperspectrally imaging the surgical field with a hyperspectral imager and displaying the hyperspectral image on a display. An image of the surgical field is captured with a camera, and the captured image is displayed on the display. The hyperspectral image is registered with and integrated with the camera image to produce the augmented virtual view thereby enhancing identification of tissue or anatomical structures in the augmented virtual view. The hyperspectral imager may be a head mounted device and the display may be an opaque display.

In any of the embodiments, the hyperspectral imager may be a black and white camera that uses selectable specific wavelengths.

These and other embodiments are described in further detail in the following description related to the appended drawing figures.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a filter mosaic.

FIG. 2 illustrates a head mounted system for providing an augmented view.

FIGS. 3A-3B show hyperspectral imaging.

FIGS. 4A-4B show hyperspectral imaging.

FIGS. 5A-5D show augmented views of a surgical field.

FIG. 6 shows an augmented view of a patient's arm.

FIG. 7 illustrates projection of an image onto the patient.

FIGS. 8A-8B illustrate an augmented view.

FIG. 9 illustrates an optical see through system for observing an augmented view.

FIG. 10 illustrates a video system for providing a virtual augmented view.

FIG. 11A shows an image seen by a camera and then projected back onto the patient or displayed in a head mounted display or any of the other displays disclosed herein.

FIG. 11B shows the augmented view.

FIG. 12 shows an augmented view projected onto a patient.

### DETAILED DESCRIPTION OF THE INVENTION

The present invention will be described in relation to the use of a hyperspectral imager used to provide an image to a surgeon to help identify tissue in the surgical field. The hyperspectral image may be displayed on a display that is registered with and overlaid with the actual surgeon's view of the surgical field to provide an augmented view. Alternatively, the hyperspectral image may be registered with and combined with a view of the surgical field that is shown on a display creating a virtual view that the surgeon can watch during the procedure. Furthermore, the hyperspectral view may be projected on to the surgical site to help the surgeon see certain anatomical targets and tissues. The display may be a heads up display in the augmented view, or the display may be a monitor, tablet display, etc. in the virtual display. Any of the displays may be head mounted. Preferably, the field of view is a surgical field having various tissues and anatomical structures. The main advantage of combining the two modalities is to enable the surgeon to continuously have direct or indirect visualization of the patient (though the see through display or other display) and the hyperspectral imager overlaying or otherwise projecting critical information directly in the line of sight.

Hyperspectral Imaging

Hyperspectral imaging, also known as imaging spectroscopy, is an imaging technique that integrates conventional digital imaging with spectroscopy. In conventional spectroscopy, the signal at every wavelength within a spectral range is recorded only for a single location. However, a hyperspectral imager generates images that provide spatial information along with spectral information for each pixel in the image. Hyperspectral images, often referred to as image cubes or hypercubes, are a three-dimensional arrangement of information, two along the spatial dimension and one along the spectral dimension. This arrangement is analogous to a stack of images of a target of interest, where each image is acquired at a different narrow spectral band. Each pixel in the image cube, therefore, represents the spectrum of the scene at that particular point. The spectral as well as the spatial data contained in hyperspectral images provide information that can be used to analyze, detect, and identify objects present in the area of study.

The typical hyperspectral imager consists of an illumination source, a spectrograph or collection of bandpass filters, and a sensor, usually a solid-state detector such as a charge-coupling device (CCD) camera. Traditionally only two dimensions of the hyperspectral data can be captured at one time, since image capture devices are usually two-dimensional, with different techniques employed to capture the remaining dimension depending on the application. In stationary applications, hyperspectral images can be acquired by fixing the field of view, i.e., the spatial dimension, and capturing the spectral dimension by sequentially obtaining images of the target at different wavelengths. This can be accomplished by using narrow band pass filters in front of the camera and varying the central wavelength, with devices like filter wheels or an electronically tunable filter such as a liquid crystal tunable filter or an acousto-optic tunable filter. A different technique known as “push-broom” acquisition, can be used if the sensor is moving over the target or if the target is in motion, such as in a conveyor belt. The hypercube is captured using a line-scan spectrometer positioned so as to repeatedly capture one spatial line at a time with its corresponding spectra, while the scanner, or target, moves normal to the line-scan direction. However, a recent method of capturing hyperspectral images has displayed the capability of acquiring both the spatial and spectral information simultaneously. In this approach the different filters needed to generate the spectral dimension are attached to a monochrome image sensor. Analogous to digital color camera sensors, which use a repeating unit cell of red, green, and blue filters over a photosensor (i.e., the Bayer pattern), a repeating unit cell of narrowband filters are placed over a photosensor, allowing an image to be acquired from each of the spectral channels in the cell in a single exposure.

As mentioned above, the added spectral dimension in hyperspectral imaging provides more detailed information about how light interacts with objects in an imaged scene than conventional imaging. This feature, in conjunction with the fact that it is inherently non-invasive, has made hyperspectral imaging an attractive tool for clinical applications. Studies have shown the potential of hyperspectral imaging in a number of applications such as: in vivo imaging of oxygen saturation in hemoglobin, imaging of teeth for dental caries detection, visualization of normal and ischemic tissue, cancer detection and residual tumor identification, and characterization of vascular structures, among others. As different wavelengths interact in distinctive ways with varying tissue types, these measured spectral responses can serve as “fingerprints” used to differentiate among tissue types. A typical method of processing hyperspectral imaging data in this context, named the stored signature approach, involves the comparison of the measured spectral response with a stored spectral signature of the tissue of interest. These stored signatures are usually acquired a priori, and stored in spectral libraries or data banks. Another approach uses theoretical and/or empirical models of light interaction with tissue to analyze and study physiological phenomena based on the measured spectra. An example of this approach is the use of known absorption properties of oxy- and deoxyhemoglobin to obtain maps oxygen saturation from hyperspectrally imaged tissue.

The information provided by hyperspectral imaging may also be used to design and develop targeted imaging instrumentation for clinical/surgical purposes. By using the spectral information, along with the spatial context, it would be possible to analyze and obtain a subset of wavelength bands that best highlight or differentiate specifics types of tissues in a particular clinical setting. The knowledge gained by this analysis can then be used to develop more sensitive detectors at those particular wavelengths and construct an imaging platform targeted to a specific application. This type of analysis can also serve to develop illumination platforms that, by using specific wavelengths of light, improve the visual detail of the clinical scene. Since hyperspectral imaging is not necessarily limited to the visible range of the electromagnetic spectrum, especially if wavelengths in the near-infrared region are found to be most informative, a false color imaging system could be conceived where individual images at particular informative wavelengths bands are collected with a monochrome sensor by sequentially alternating light sources tuned to this wavelengths, creating a composite false color image where different tissues or physiologies are highlighted.

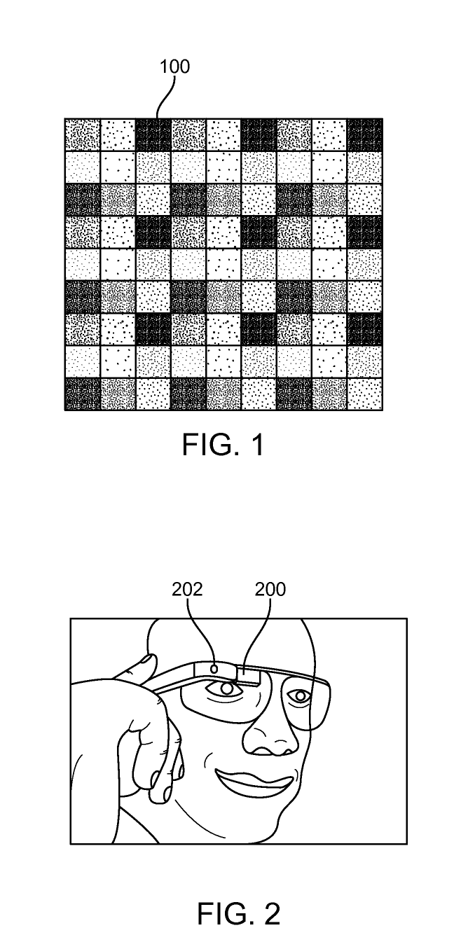

A typical sensor may contain various filter patterns. Such as a filter mosaic 100, where multiple bands are constructed for each pixel, as seen in FIG. 1. The sensor may have only desired filters on each pixel or the sensor may be black and white with the light engine providing the spectrum.

FIG. 2 shows a heads up display 200 (such as Google Glass) that is operatively coupled with a hyperspectral imager camera 202. The camera is mounted on the head mount with the display. Proper registration is required so that the hyperspectral image is displayed over the field of view of the user and through the display.

The hyperspectral imager provides an alternative image of the surgical field based on reflectance, absorption or transmission of various wavelengths of light by tissue and anatomical structures in the surgical field. Due to the varying reflectance, transmission or absorption of the various wavelengths by the different tissues, the different tissues and anatomical structures may be more clearly distinguished from one another. The image from the hyperspectral imager camera 202 may be displayed in the heads up display 200 and this may be placed adjacent the surgical field so that the hyperspectral image is registered with and superimposed over the actual view of the surgical field seen by the surgeon. Thus, the surgeon may look through the heads up display to see the actual surgical field, and the hyperspectral image is superimposed on top of his or her actual view of the surgical field. This then allows the surgeon to more clearly determine tissue margins or boundaries between adjacent anatomical structures during surgery. This can help a surgeon identify more clearly the diseased and damaged tissue to be removed, or prevent healthy tissue from being damaged or disturbed during a surgical procedure on adjacent tissue.

In any of the embodiments disclosed herein, the hyperspectral imager provides real time images of the surgical field which may be registered with and superimposed over what the surgeon actually is viewing. In addition, overhead lighting, fiber optic illumination, illuminated surgical instruments such as retractors with optical waveguide illumination elements may be used to help illuminate the surgical field with light to help the surgeon visualize the surgical field.

In use, illumination is provided by any of the known illumination devices to provide light to the surgical field while a surgeon is viewing the surgical field. The hyperspectral imager is also aligned with the surgical field to have the same field of view as the surgeon, as well as same gaze or angle as the surgeon. The hyperspectral imager then obtains an image of the surgical field. The hyperspectral image is then overlaid in the heads up display and registered with the actual image that the surgeon sees, thereby providing an augmented view of the surgical site which helps the surgeon to distinguish between various tissue or anatomical structures in the surgical field.

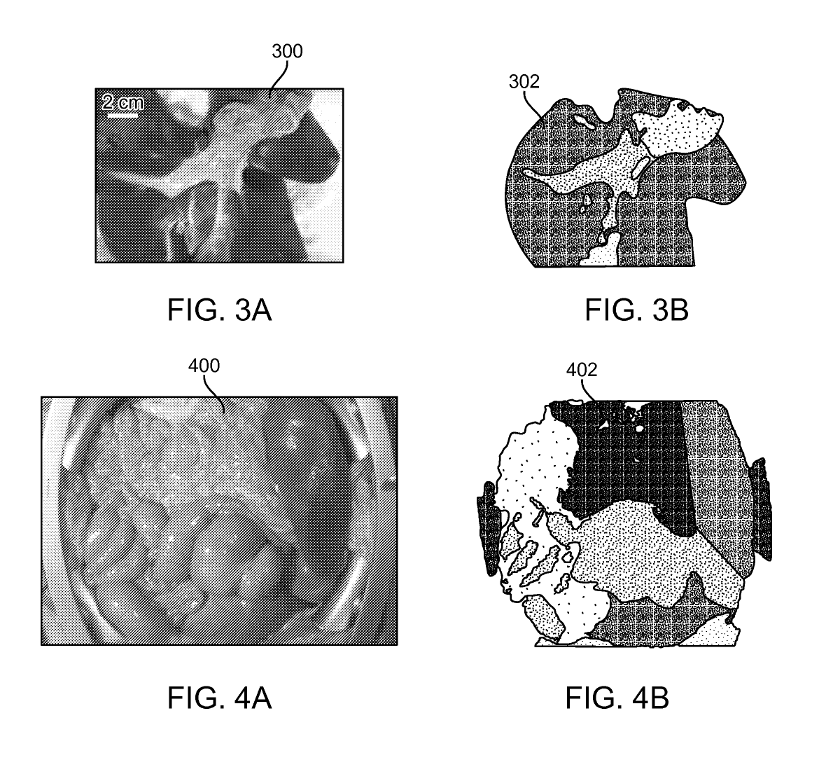

For example, FIG. 3A illustrates an actual image of abdominal tissue 300 as seen by a surgeon. While some tissue or anatomical structures is easily seen, some margins or tissue is unclear. FIG. 3B illustrates an image of the same abdominal tissue 302 obtained with a hyperspectral imager. The various tissues, anatomical structures and margins are now even more clear, and this can be superimposed over the actual view that the surgeon sees using one of the displays previously discussed (or any other display known in the art) to help the surgeon visualize the surgical field.

FIGS. 4A-4B illustrate another exemplary embodiment of a surgeon's view of tissue and a hyperspectral view of the same tissue. FIG. 4A illustrates an actual surgeon's view of the tissue 400 and anatomical structures in the abdomen. FIG. 4B illustrates a hyperspectral view of the same area 402. Again, FIG. 4B helps to more clearly visualize the various tissues, anatomical structures and margins in the surgical field. Thus, superimposing the hyperspectral view over the actual surgeon's view with any of the displays described above can facilitate the surgeon's work in the surgical field.

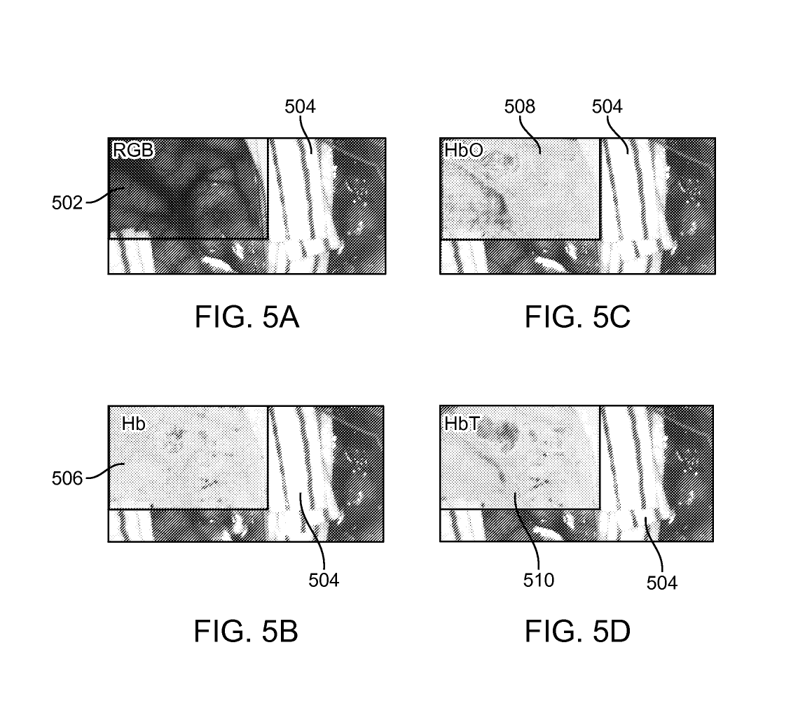

FIG. 5A illustrates a normal view of target tissue 502 (here abdominal tissue) in a surgical field 504. In FIG. 5B a hyperspectral image 506 is registered with and superimposed over the surgeon's natural view of the surgical field 504 to create an augmented view. The hyperspectral image emphasizes the hemoglobin (Hb) in the tissue. Similarly, the hyperspectral image 508 in FIG. 5C emphasizes oxygenated hemoglogin (HbO) and this image is registered with and superimposed over the normal surgeon's view 504 to form an alternative augmented view. FIG. 5D shows hyperspectral image 510 which emphasizes total hemoglobin concentration (HbT) and is registered with and superimposed over the normal surgeon's view 504 to form another augmented view of the surgical field. FIGS. 5A-5D show the view that a surgeon would see through head worn display, such as the glasses in FIG. 2.

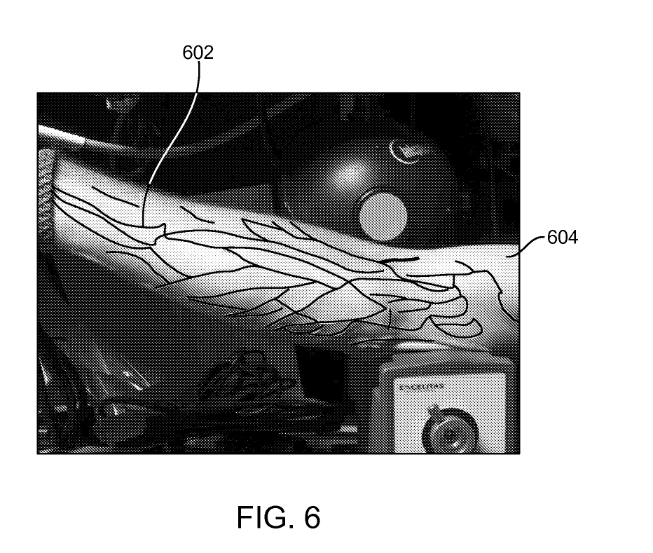

FIG. 6 illustrates an actual hyperspectral view superimposed over an actual view of a patient's arm. The hyperspectral image highlights blood vessels 602 in the arm 604, thereby allowing the surgeon to avoid the vessels during surgery, or target specific vessels during a procedure.

In the exemplary embodiments described above, the hyperspectral image is displayed on a heads up display or other display unit which then allows the image to be superimposed on top of the surgeon's actual field of view. The surgeon looks through the heads up display to see the surgical field with the augmented image superimposed on his normal view. In an alternative embodiment which may be employed in any of the embodiments disclosed herein, instead of displaying the hyperspectral image on a display unit, the hyperspectral image may be projected directly onto the target area of the patient as will be discussed later.

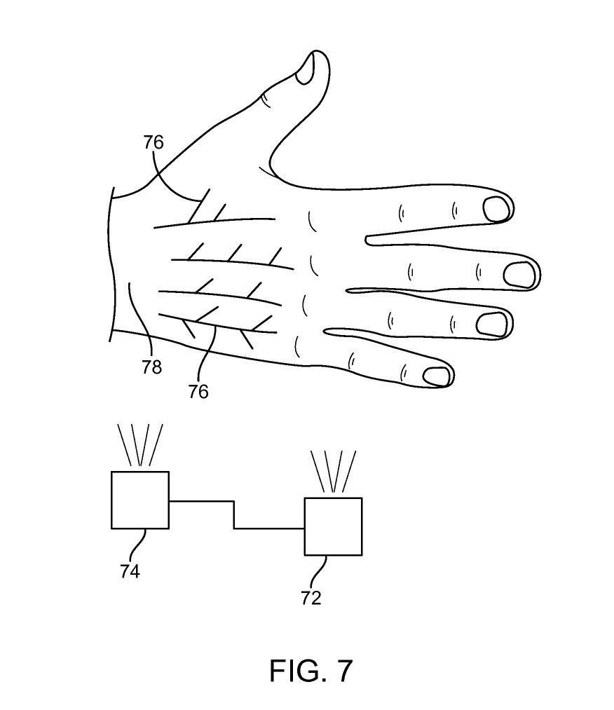

FIG. 7 illustrates an exemplary embodiment of a patient's hand 78. A hyperspecral camera 74 is used to differentiate specific tissue and capture an image of the target tissue. The information is processed by software and then an image 72 is displayed by a projector back onto the target tissue. The projector may be laser based or LED based or other light based (the resulting image is not a hyperspectral, the camera for obtaining the image is hyperspectral and analyzes the images where only specific tissue is imaged/enhanced). The image is then projected onto the target, here a hand without changing the color perception of the rest of the image. Here, veins 76 have been identified in the hyperspectral image and then projected onto the patient's hand so that the surgeon knows precisely where the vessels are. The presently disclosed embodiment preferably augments information by capturing tissue of interest, registering the image against the actual scene and displaying it over the scene without changing the color of the rest of the scene.

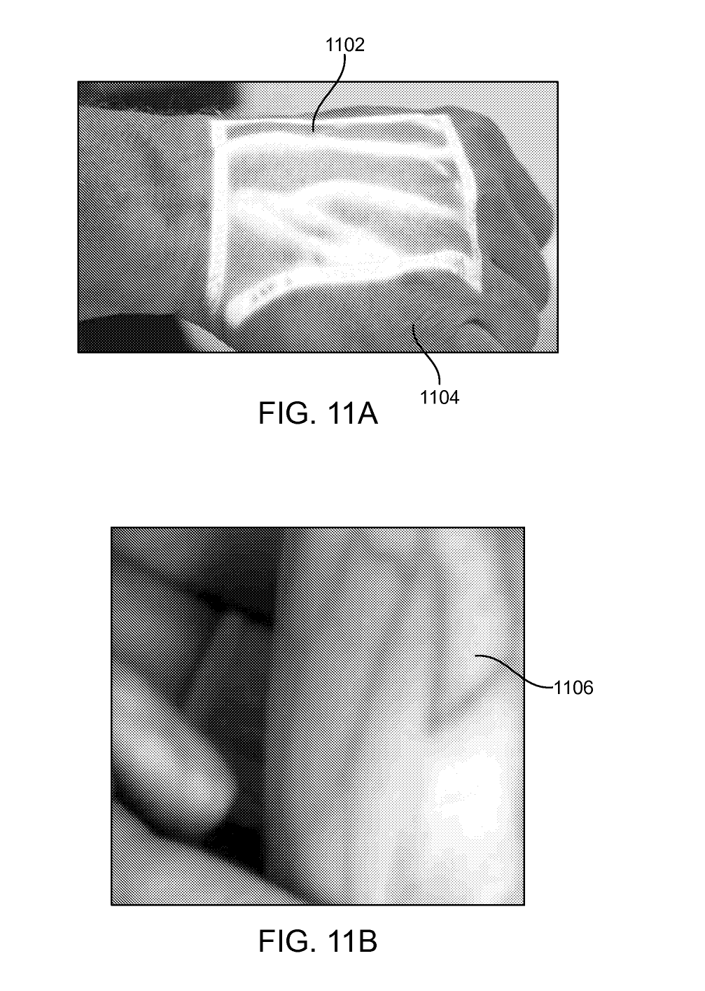

FIG. 11A shows an image 1102 seen by a camera and then projected back onto the patient 1104 or displayed in a head mounted display or any of the other displays disclosed herein. FIG. 11B shows the augmented view 1106.

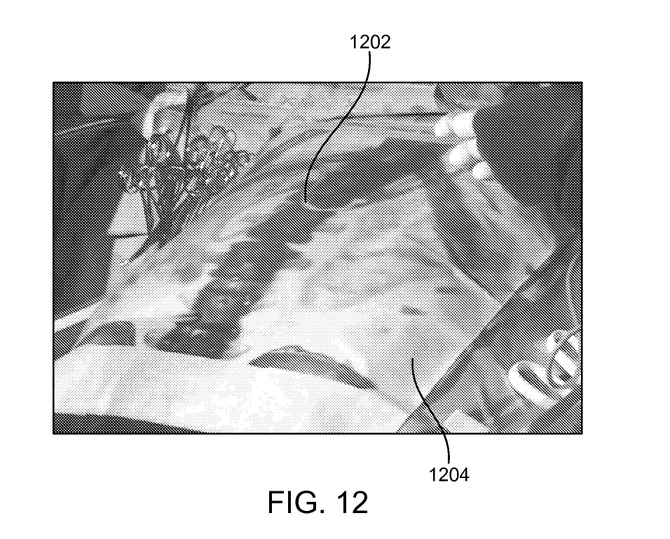

FIG. 12 similarly shows a hyperspectral image that has been captured with a hyperspectral camera and then projected back onto the patient. Here the image emphasizes spinal tissue 1302 and is projected onto the patient's back 1304.

Other commercially available devices project an entire section of an image onto the target area. The reason other systems image the entire scene is because they are not providing augmented information. They simply re-display what the camera captures. This preferred embodiment projects only the image of the desired tissue or anatomical structures directly onto the target area, hence only the blood vessels are visible on the hand in FIG. 7, or only the spinal tissue is projected in FIG. 13. Thus, the intermediate display previously described is not necessary since the image is projected directly onto the target work area creating an augmented image that a surgeon or other physician can use to help avoid or locate target tissue or target anatomical areas. The surgeon therefore is not limited to viewing the surgical field through a display such as a heads up display, and the surgeon my directly view the site. The image may be black and white or color and the projected color may be used to highlight tissues hence different colors for different tissues maybe used.

Therefore, in any of the embodiments described herein, a see through display, a hand held monitor (e.g. tablet screen) or other monitor may be used to view the hyperspectral image. The hyperspectral camera may be mounted onto the see through display, hand held monitor or other monitor, or the hyperspectral camera may be separate therefrom. Thus, when the see through display, hand held monitor or other monitor is placed over the incision, the hyperspectral image is then displayed therein. The information may therefore be displayed on a see through display or an opaque display. An example of an opaque display includes an iPad with a regular camera as well as the hyperspectral camera so that an image of the surgical field from the regular camera is observed on the iPad screen and the image from the hyperspectral camera is also viewed superimposed on top of the regular image, creating a virtual view which the surgeon may observed during the procedure. The monitor may therefore be placed in the field and displays the entire field with the tissue of interest enhanced. If the monitor is a see through monitor, then only the area of interest is displayed on the monitor and the augmented image is registered with the area of interest and can be seen through the display.

There are two types of augmented reality systems. The first is an optical see through system and the second is a video see through system. The video see through system displays the entire image from a camera capturing the area of interest on the screen. The hyperspectral image is overlaid on top of that image. In the optical see through system only the area of interest is highlighted.

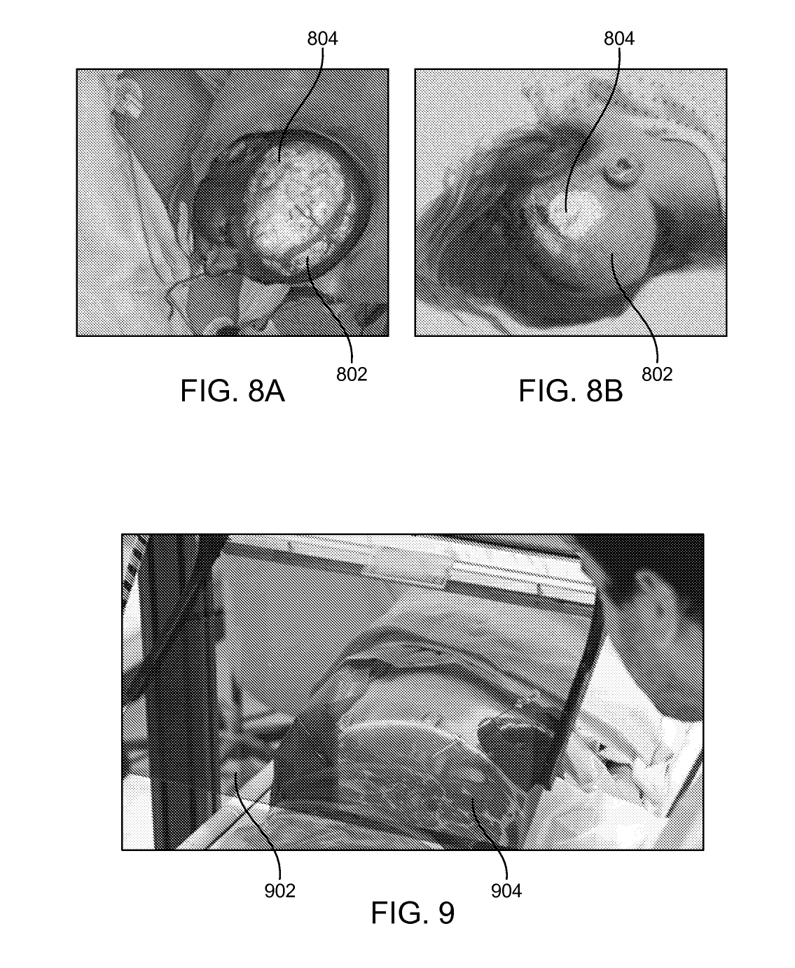

FIGS. 8A-8B illustrate exemplary embodiments of an optical see through system for augmenting a surgeon's view. In FIGS. 8A-8B augmented views 804 of anatomical structures are seen superimposed on top of an image of the patient's head 802. The augmented view may be viewed in any of the embodiments described herein.

FIG. 9 illustrates another exemplary embodiment of a see through display used to create an augmented view. The see through display 902 is disposed over the patient. A camera may be optionally built into the display, however in this embodiment the camera is separate from the see through display. A computer generated image 904 is displayed on the see through display and is also registered with the actual anatomy so that the surgeon can see an augmented view of the patient with various anatomy highlighted.

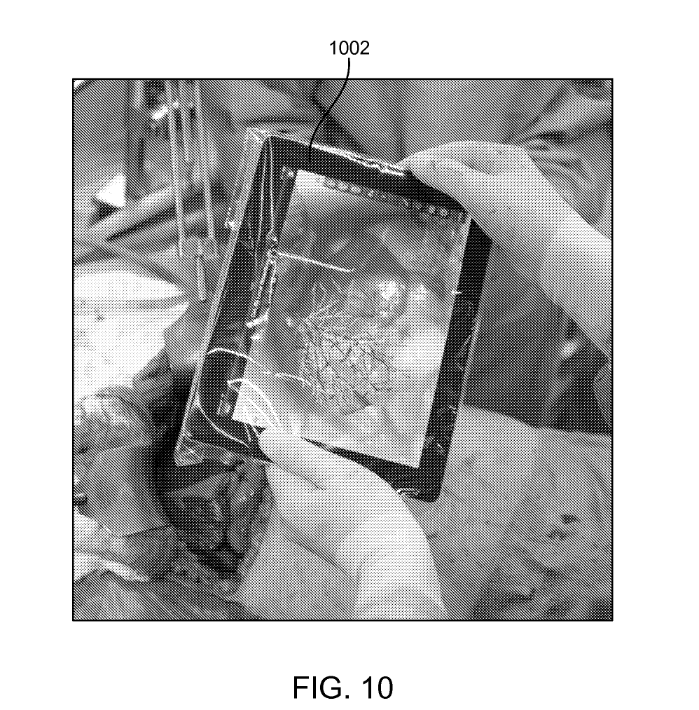

FIG. 10 illustrates an exemplary embodiment of a video see through system where the entire scene is shown on the monitor 1002. Here, a video system such as an iPad captures an image of the actual anatomy and the hyperspectral image is superposed on top of the actual anatomy to provide the surgeon with an augmented virtual view of the surgical field.

In addition to utilizing the hyperspectral camera and image in conjunction with a surgeon's view of a surgical field, a similar concept may be applied to a microscope or any other viewing instrument. For example, in the case of a microscope, a heads up display or other display may be placed over the eye pieces of a microscope or other viewing means for observing the magnified image of the specimen under the microscope. A hyperspectral imager provides a hyperspectral image of the specimen, and displayed on the heads up display or other display which then overlays the hyperspectral image on top of the view of the specimen from the microscope. This allows various features such as cells or other structures to be highlighted. This may be an add on device to existing microscopes, potentially mounted on the eyepieces.

In addition to the hyperspectral imager, other cameras and other sensors may be coupled with any of the embodiments disclosed herein, thereby providing another image which further help a surgeon or other operator to distinguish different tissues, anatomical structures, etc. from adjacent tissue and structures. For example, a thermal sensor may be used to provide another image. The image may be stereoscopic.

Another aspect of the present system is registration of the hyperspectral image with the actual image over which the hyperspectral image is overlaid. This can be accomplished in a number of different ways, however, in one embodiment, a mark or other target may be disposed on a surgical glove worn by the surgeon. The hyperspectral image captures an image of the surgeon's hand with the marked glove, and then this image can be registered with the actual view of the surgeon's hand and glove. Once this is accomplished, the rest of the hyperspectral image will also be registered with the surgical field. Other targeting mechanism may also be employed to accomplish the registration.

In still other embodiments, hand gestures may be employed to help control other equipment in the operating room or room being used. Various dicom images may be streamed into the displays as well, and the hyperspectral image may provide both the gesture control information as well as tissue imaging.

In yet other embodiments, a camera may be used in conjunction with a display such as a heads up display or any of the other displays discussed herein or known in the art to measure objects. For example, a surgeon or other operator can look into a surgical field at a target and then use his or her fingers to trace around the target. This may be calibrated against a known target (e.g. a QR code or barcode) and then measurements of the traced target may be obtained through the see through display and calculated.

In still other embodiments, the see through display may be used to provide a computer navigation overlay. Again, an augmented display may be created with a camera. A surgical instrument or other tool may be observed along with an overlaid trajectory of the tool. For example, in the case where the tool is a surgical drill bit, the trajectory of the drill bit drilling through a bone may be displayed to help ensure that the surgeon drills in the correct direction and to the correct depth. Also, using head mounted cameras for a means to view surgical instruments with fiducial targets such as reflectors or printed targets would eliminated any need to have large cameras off the surgical field.

A small projector may be added to the heads up display or other display device and this may be used to project a pattern on an object and a second camera may then be used to look at pattern distortion to help measure the object. Time of flight cameras may also be used where an object moves relative to a camera allowing measurement of the object.

Thus, the presently presented systems provide an augmented image to the surgeon to help the surgeon identify the various tissues, margins and anatomical structures in the surgical field as well as measure them or project a projected path of motion of a surgical instrument being used. The augmented image may be registered with and superimposed over the surgeon's actual view, or the image may be combined with the surgeon's view captured by a camera and both displayed virtually in a real time display.

Additionally, since the surgeon's hand has been registered with the actual view seen by the surgeon, hand gestures may now also be used by the system to control various screens, images, etc. that appear on the heads up display, similar to what is used in video games such as Xbox Connect, or Wii games.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A system for augmenting a surgeon's view of a surgical field, said system comprising:
a hyperspectral imager configured to provide a hyperspectral image of a surgical field; and
a display for displaying the image provided by the hyperspectral imager, wherein the hyperspectral image is displayed on the display, and
wherein the hyperspectral image is superimposed with and registered with an actual view of the surgical field as seen by the surgeon to form an augmented view of the surgical field.

2. The system of claim 1, wherein the hyperspectral imager is coupled to the display and the display is a see through display.

3. The system of claim 2, wherein the display is a heads up display.

4. The system of claim 1, wherein the hyperspectral imager is a head mounted device.

5. A method for augmenting a surgeon's view of a surgical field, said method comprising:
hyperspectrally imaging the surgical field with a hyperspectral imager;
displaying the hyperspectral image on a display;
registering the hyperspectral image with an actual view of the surgical field as seen by the surgeon;
overlaying the hyperspectral image on top of the actual view thereby forming an augmented view; and
enhancing identification of tissue or anatomical structures in the augmented view.

6. The method of claim 5, wherein the hyperspectral imager is a head mounted device.

7. The method of claim 5, further comprising viewing the surgical field through the display.

8. The method of claim 5, wherein the display is a heads up display.

9. A system for augmenting a surgeon's view of a surgical field and providing a virtual view of the surgical field, said system comprising:
a hyperspectral imager configured to provide a hyperspectral image of a surgical field;
a camera for imaging the surgical field; and
a display for displaying both the image provided by the hyperspectral imager and the image provided by the camera, wherein the hyperspectral image is registered with and integrated with the image provided by the camera to produce the augmented virtual view of the surgical field.

10. The system of claim 9, wherein the display is an opaque display.

11. The system of claim 9, wherein the hyperspectral imager is a head mounted device.

12. A method for providing an augmented virtual view of a surgical field, said method comprising:
hyperspectrally imaging the surgical field with a hyperspectral imager;
displaying the hyperspectral image on a display;
capturing an image of the surgical field with a camera;
displaying the captured image on the display, wherein the hyperspectral image is registered with and integrated with the camera image to produce the augmented virtual view; and
enhancing identification of tissue or anatomical structures in the augmented virtual view.

13. The method of claim 12, wherein the hyperspectral imager is a head mounted device.

14. The method of claim 5, wherein the display is an opaque display.

15. A system for augmenting a surgeon's view of a surgical field, said system comprising:
a hyperspectral imager configured to provide a hyperspectral image of a surgical field; and
a projector for projecting the hyperspectral image onto the surgical field, wherein the hyperspectral image is projected directly onto the surgical field thereby enhancing identification of tissue or anatomical structures in the surgical field.

16. The system of claim 15, wherein the hyperspectral imager is a head mounted device.

17. A method for augmenting a surgeon's view of a surgical field, said method comprising:
hyperspectrally imaging the surgical field with a hyperspectral imager;
projecting the hyperspectral image from a projector directly onto the surgical field; and
enhancing identification of tissue or anatomical structures in the surgical field.

18. The method of claim 17, wherein the hyperspectral imager is a head mounted device.
